(19) United States
(12) Patent Application Publication
(10) Pub. No.: US 2020/0042881 A1
(43) Pub. Date: Feb. 6, 2020

(54) Methods and Apparatus of Core Compute Units in Artificial Intelligent Devices

(71) Applicant: Nanjing Iluvatar CoreX Technology Co., Ltd. (DBA "Iluvatar CoreX Inc. Nanjing"), Nanjing (CN)

(72) Inventors: Yunxiao Zou, Shanghai (CN); Pingping Shao, San Jose, CA (US); Min Cai, Shanghai (CN); Jinshan Zheng, Shanghai (CN); Guangzhou Li, Shanghai (CN)

(73) Assignee: Nanjing Iluvatar CoreX Technology Co., Ltd. (DBA "Iluvatar CoreX Inc. Nanjing"), Nanjing (CN)

(21) Appl. No.: 16/237,618

(22) Filed: Dec. 31, 2018

(30) Foreign Application Priority Data
Aug. 1, 2018 (CN) 201810863952.4

(51) Int. Cl. G06N 3/10; G06F 17/16; G06N 3/04

(52) U.S. Cl. CPC G06N 3/10; G06N 3/04; G06F 17/16

(57) ABSTRACT

A core computing unit processor and a processing method for an artificial intelligence device, wherein the processor is provided with a plurality of neurons, wherein the neuron is composed of a plurality of multiplier groups. The multiply-adder group includes a plurality of multiplier units having an operation function of accumulating, maxima, and minimum values, and the number of multiplier groups in each neuron is the same, and each of the multiplier groups is The number of multiplier units is the same, the multiplier group in one neuron shares the same input activation data, and the multiplier group in one neuron processes different kernel weight data, but multiply and add the same order in different neurons. The device group processes the same kernel weight data, and there is no data conversion between each multiplier group.

### CROSS-REFERENCE TO RELATED APPLICATION

This U.S. nonprovisional patent application claims priority to a Chinese invention application serial number 201810863952.4, filed on Aug. 1, 2018, whose disclosure is incorporated by reference in its entirety herein.

### TECHNICAL FIELD

Embodiments of the invention generally relate to the field of artificial intelligence technology, and particularly relate to a core computing unit processor and an acceleration processing method for an artificial intelligence device.

### BACKGROUND

The core computing unit is a key component of the AI (Artificial Intelligence) device. The existing chips for artificial intelligence include CPU (Central Processing Unit), GPU (Graphical Processing Unit), TPU (Tensor Processing Unit) and other chips. The CPU requires a large amount of Space to place memory cells and control logic, compared to computing power only a small part, extremely limited in large-scale parallel computing capabilities, and better at logic control; in order to solve the CPU in large-scale parallel computing Difficulties encountered, GPU came into being, using a large number of computing units and ultra-long pipeline, good at processing acceleration in the image field; TPU can provide high-throughput low-precision calculations for the forward operation of the model, phase Compared to GPUs, TPUs have a slightly lower power consumption, although their computing power is slightly inferior. Usually GPUs have tensor cores that implement small matrix multiplication and addition. TPUs have pulsating arrays for matrix multiplication. In AI workloads, convolution and matrix multiplication are the most power consuming, and in existing GPUs and TPUs. The compiler must convert the convolution to some matrix multiplication, however this conversion is not efficient and has more power.

### SUMMARY

In view of the deficiencies of the prior art, the present invention provides a core computing unit processor and an acceleration processing method for an artificial intelligence device, the technical solution of which is:

A core computing unit processor for an artificial intelligence device, comprising a plurality of neurons, wherein the neurons are composed of a plurality of multiplier groups, the multiplier group comprising a plurality of multipliers a unit, the multiplier unit has an operation function of accumulating, maximizing, and minima, the number of multiplier groups in each neuron is the same, and the number of multiplier units in each multiplier group is the same, within one neuron The multiplier group shares the same input activation data, and the multiplier group in one neuron processes different kernel weight data, but the multiplier group in the same order in different neurons processes the same kernel weight data, and each multiply-add There is no data conversion between the groups.

Based on the above solutions, further improvements or preferred solutions include:

The processor includes four neurons, the neurons consisting of eight multiplier groups, and the multiplier group includes four multiplier units.

The input end of the multiplier unit is respectively connected with a weight register and an input activation register, and the multiplier unit is provided with a multiplier MAC, a plurality of target registers and a plurality of export registers; the target register and the multiplier The MAC connection is used to store the weight and the calculation result of the input activation data; the export register is connected to the target register and is in one-to-one correspondence with the target register, and is used for deriving the calculation result.

The multiplier unit is provided with four export registers and four target registers.

The processor includes a buffer L1 for storing input activation data and weight data distributed by an external module, and the input activation register and the weight register call data from the buffer L1.

The external module is a wave tensor dispatcher.

The method for accelerating processing of a core computing unit based on the artificial intelligence device as described above, comprising the steps of:

The data processed by the multiplier unit includes non-zero weight data and its position index in the kernel, input activation data and its position index in the feature map, and different kernel weight data are respectively mapped into one neuron. Different multiplier groups are broadcast to the corresponding multiplier group in other neurons; the multiplier group processing in one neuron shares the same input activation data, with the same feature dimension, but from different input channels The input activation data is accumulated in the same multiplier group, which is the position of the input activation data on the feature map.

In the multiplier unit, the result of multiplying the weight data by the input activation data is either accumulated or compared with the previous result to obtain the maximum or minimum result and stored in the destination register.

The processor is provided with 4 neurons, the neuron is composed of 8 multiplier groups MAC4, the MAC4 includes 4 multiplier units, and the multiplier unit is provided with a multiplier MAC, 4 The target register is corresponding to the four export registers, the target register and the export register are in one-to-one correspondence, and the input end of the multiplier adder MAC is respectively connected with the weight register and the input activation register; the target register is connected with the output end of the multiplier MAC, A calculation result for storing weights and input activation data; the export register is connected to a target register for deriving the calculation result.

The weighting data of the 3×3 kernel of the acceleration processing method and the input activation data matching algorithm include the following steps:

Let a multiplier group MAC4 include 4 identical multiplier units MACn. For a wave tensor with 16 destinations, each multiplier unit MACn can process 4 of them, so a multiplier The unit MACn includes four target registers OAmn, n and m are a natural number from 0 to 3, that is, each of the multiplier groups is provided with a target register array of 4 rows and 4 columns, and m and n respectively represent each target. The rows and columns of registers in the display;

The weight data and its position index (i, j) in the kernel are received by a multiplier group MAC4, which also receives the input activation data placed in a 6×6 feature map array with them. a position index (s, t) in the array, the i and j respectively representing a row and column of the 3×3 kernel array, the s and t respectively representing a row and column of the 6×6 feature map array, i, j being 0 to a natural number in 2; s, t is a natural number from 0 to 5;

For each weighted array element W(i,j), all input activation data whose position satisfies the condition 0<=(si) <=3 and 0<=(tj) <=3, and the W(i,j)) are sent together to MAC(tj), they are multiplied, and the result is processed by the target register (sj). This processing is cumulative, maximum or minimum according to user requirements, and tj and sj are a natural number from 0 to 3. The calculation result of sj represents the row coordinate of the target register, and the calculation result of tj represents the column coordinate of the target register, or the n value of MACn.

### Beneficial Effects

The present invention relates to a core computing unit processor and method for an artificial intelligence device, which arranges kernels in a manner of reusing weights and activations, and can quickly acquire data from a cache and broadcast them to a plurality of multiplier MACs. To achieve higher processing efficiency and lower power consumption.

### BRIEF DESCRIPTION OF DRAWINGS

In order to more clearly describe the technical schemes in the specific embodiments of the present application or in the prior art, hereinafter, the accompanying drawings required to be used in the description of the specific embodiments or the prior art will be briefly introduced. Apparently, the drawings described below show some of the embodiments of present application, and for those skilled in the art, without expenditure of creative labor, other drawings may be derived on the basis of these accompanying drawings.

FIG. 1 shows the artificial intelligence feature map and kernel and calculation formula according to one embodiment of the invention.

FIG. 2 is a schematic diagram of matrix multiplication according to one embodiment of the invention.

FIG. 3 is a flow chart of the engine according to one embodiment of the invention.

FIG. 4 is a schematic diagram of an engine architecture according to one embodiment of the invention.

FIG. 5 is a block diagram of a computing processing unit according to one embodiment of the invention.

FIG. 6 is a schematic structural diagram of a core computing unit processor according to one embodiment of the invention.

FIG. 7 is a schematic structural diagram of a multiplier group MAC4 according to one embodiment of the invention.

FIG. 8 is a schematic diagram of an algorithm for matching W and IA according to one embodiment of the invention.

### DETAILED DESCRIPTION

Embodiments of the present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

In order to clarify the technical purpose and working principle of the present invention, the present invention will be further described below in conjunction with the accompanying drawings and specific embodiments.

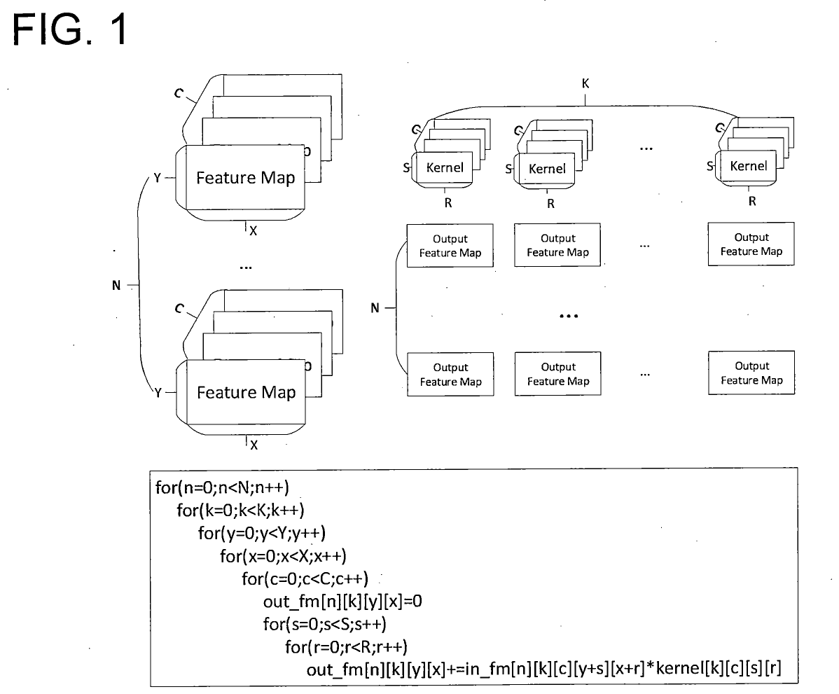

As shown in FIG. 1, the artificial intelligence feature map can usually be described as a four-dimensional tensor [N, C, Y, X], which are respectively, feature map dimensions: X, Y; channel dimension: C; batch dimension :N. The kernel can be a four-dimensional tensor [K, C, S, R], the AI work is to give the input feature tensor and kernel tensor, we calculate the output tensor according to the formula in FIG. 1 [N, K, Y, X ].

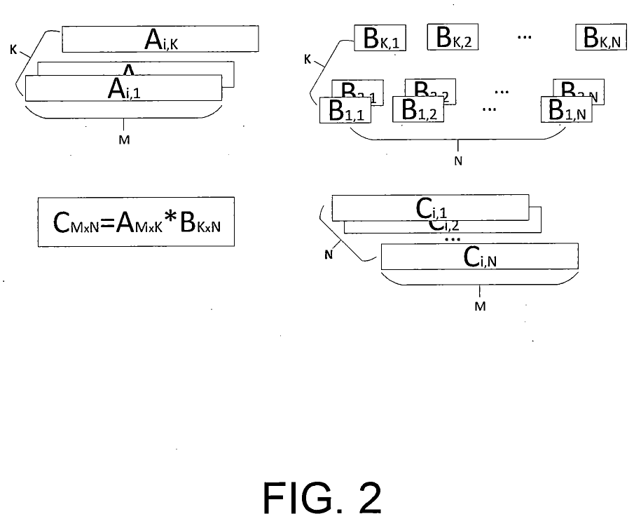

Another important operation in artificial intelligence is matrix multiplication. This operation can also be mapped to feature map processing. As shown in FIG. 2, matrix A can be mapped to tensors [1, K, 1, M], and matrix B is mapped to Tensor [N, K, 1, 1], the result C is the tensor [1, N, 1, M]. There are other operations, such as normalization and activation, which can be supported in general purpose hardware operators.

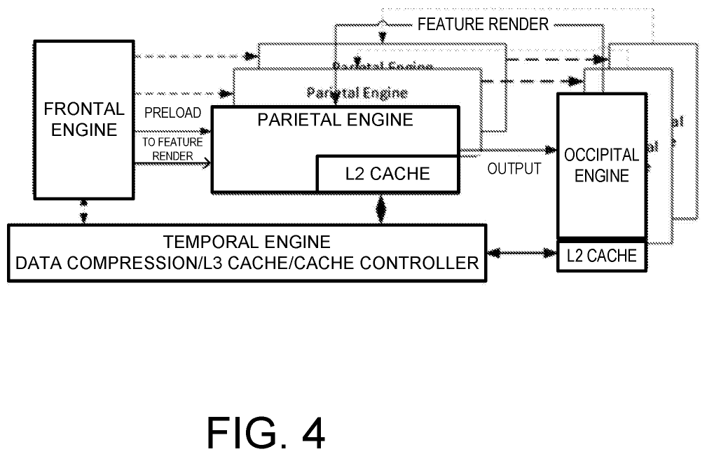

In this embodiment, we propose another hardware architecture that can support these operations effectively and more efficiently. FIG. 4 is an engine-level architecture diagram of the architecture designed by this example, which we call “artificial brain architecture”. Multiple computing power requirements are fully scalable. In general, in the Frontal Engine (FE), the tensors are divided into groups, which are sent to the Parietal Engine (PE). Each parietal engine processes the groups according to a user-defined input feature renderer (IF-Shader) and outputs the partial sum to the Occipital Engine (OE). The OE collects the output tensor and dispatches an output feature renderer to further process the tensor. There are two ways to handle the Output Feature Renderer (OF-Shader). In the unified rendering architecture, the output feature renderer is sent back to the top-temporal engine, and once the top-temporal engine finishes rendering, it sends the result back to OE. In the split rendering architecture, the output feature renderer is processed in the OE. The OE results send the output tensors to the Temporal Engine (TE), which performs some post processing and sends them to the DRAM or saves them in the cache for further processing.

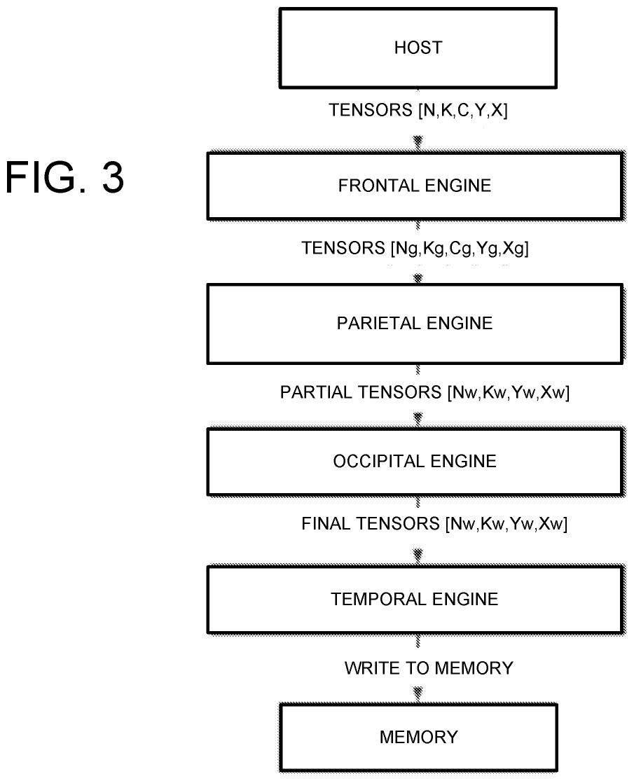

In this embodiment, the artificial intelligence work is regarded as a 5-dimensional tensor [N, K, C, Y, X], including feature map dimensions: X, Y; channel dimensions C, K, where C represents an input feature map, K Represents an output feature map; N represents a batch dimension. In each dimension, we divide the work into groups, each of which may be further divided into waves. As shown in FIG. 3, in the architecture of the computing processing unit of the present implementation, the first engine-frontal engine (FE) obtains a 5D tensor [N, K, C, Y, X] from the host and Divided into a number of group tensors [Ng, Kg, Cg, Yg, Xg], and send these groups to the parietal engine (referred to as PE); PE obtains the group tensor and divides it into several waves, sends these waves to the rendering Engine to execute the input feature renderer (IF-Shader) and output partial tensors (Nw, Kw, Yw, Xw) to the occipital engine (OE); OE accumulates partial tensors and performs output feature rendering (OF-Shader) to get the final tensor sent to the next engine-temporal engine (TE); TE performs some data compression and writes the final tensor into memory.

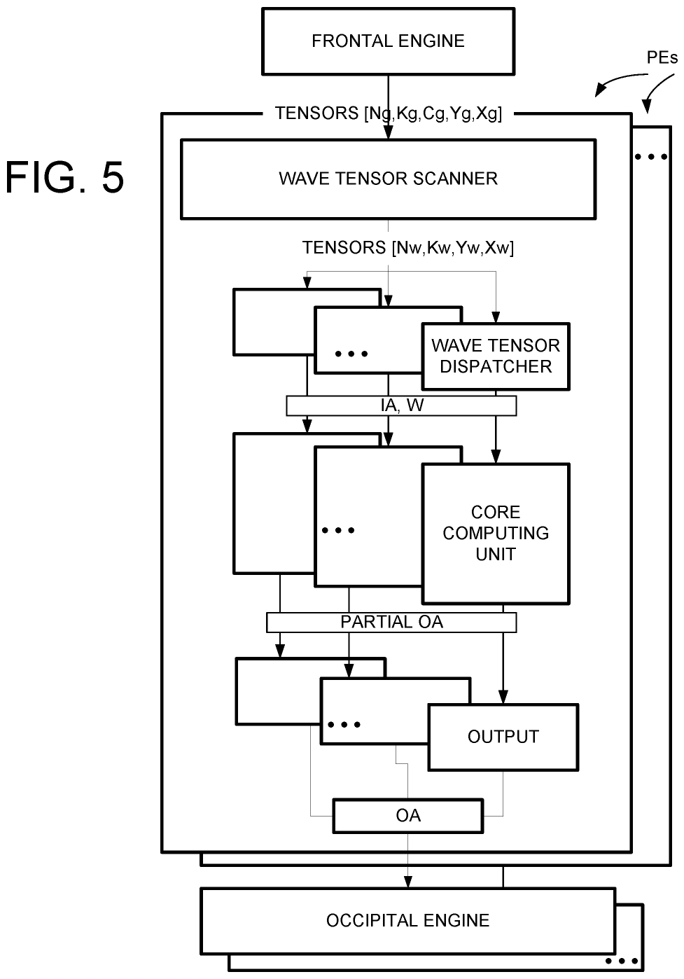

The FE sends the group tensor to multiple PEs, each PE acquires the group tensor and processes it, and outputs the result to the OE. In FIG. 5, the PE is composed of a wave tensor scanner (WTS), a wave tensor dispatcher (WTD), a “core computing unit”, and an “export”. The WTS receives the group tensors and decomposes them into wave tensors, which are sent to the WTD. The number of WTDs is configurable in the PE. The WTD loads Input Activation (IA) data and weight (W) data and dispatches it to the compute core unit. The core computing unit processes the data, and the derived block outputs the result OA to the OE. The number of core computing units and the number of exports are the same as the number of WTDs.

For the above core computing unit, the present invention provides a core computing unit processor for an artificial intelligence device, which is provided with a plurality of neurons, the neurons being composed of a plurality of multiplier groups, the multiplier group A plurality of multiplier units are included, the multiplier unit having three operations: accumulating, maximum and minimum values (sum(IAi*Wi), maximum value (max(IAi*Wi), minimum value (min(IAi) *Wi)). The number of multiplier groups in each neuron is the same, the number of multiplier units in each multiplier group is the same, and the multiplier group in one neuron shares the same input activation data, one neuron The internal multiplier group processes different kernel weight data, but the multiplier group of the same order in different neurons processes the same kernel weight data, and there is no data conversion between each multiplier group.

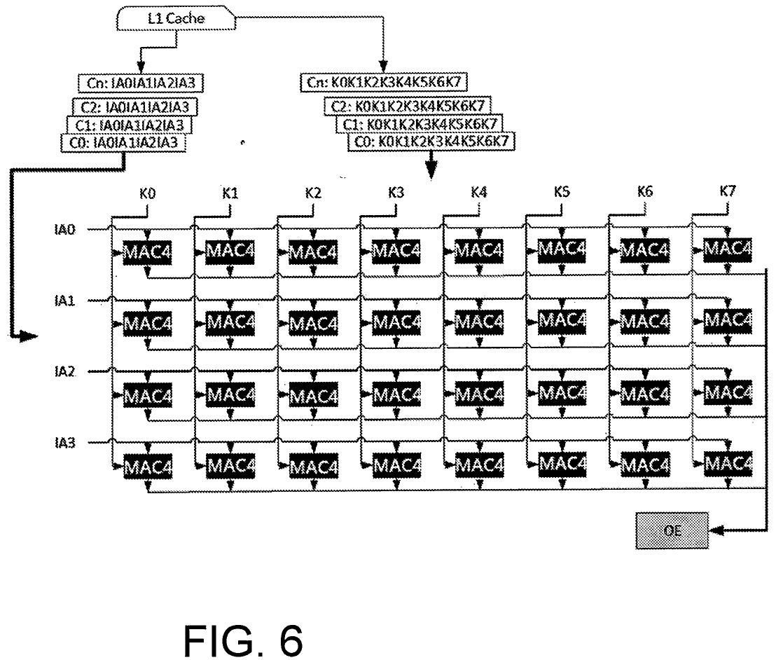

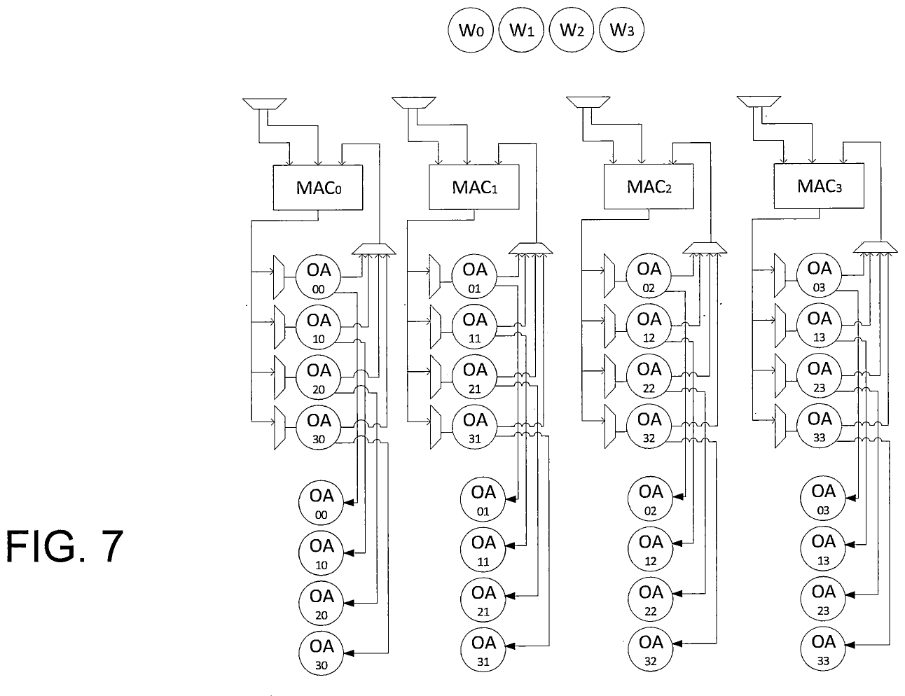

The core computing unit processor of the present invention can be used for, but not limited to, the hardware architecture proposed in this embodiment. FIG. 6 and FIG. 7 are specific processor embodiments.

As shown, the core computing unit processor is provided with 4 neurons and a buffer L1. The neuron is composed of 8 multiplier groups MAC4, each multiplier group MAC4 includes 4 multiplier units, and the multiplier unit is provided with a multiplier MAC, 4 target registers and 4 Deriving a register, the target register is in one-to-one correspondence with the export register, the input end of the multiplier adder MAC is respectively connected with the weight register (W0-W3) and the input activation register; the target register and the output end of the multiplier MAC a connection for storing a weight and a calculation result of the input activation data, the export register being connected to the target register for deriving the calculation result.

The buffer L1 is used to store input activation data and weight data assigned by the wave tensor dispatcher WTD, and the input activation register and the weight register call data from the buffer L1.

The artificial intelligence device core computing unit of the processor accelerates the processing method, and the specific process includes:

The data processed by the multiplier unit includes non-zero weight data and its position index in the kernel, input activation data and its position index in the feature map, and different kernel weight data are respectively mapped into one neuron. Different multiplier groups are broadcast to the corresponding multiplier group in other neurons; the multiplier group processing in one neuron shares the same input activation data, with the same feature dimension, but from different input channels The input activation data is accumulated, maximized or minimized in the same multiplier group. The feature dimension is the position (X, Y) of the input activation data on the feature map, and the different input channels refer to the dimension C, as shown in FIG. Input activation data for the same feature dimension but different input channels can be understood as IA at the same position of different feature maps.

In the multiplier unit, the result of multiplying the weight data by the input activation data is either accumulated or compared with the previous result to obtain the maximum or minimum result and stored in the destination register.

Taking the 3×3 core as an example, the weighting data of the 3×3 kernel and the input activation data matching algorithm are:

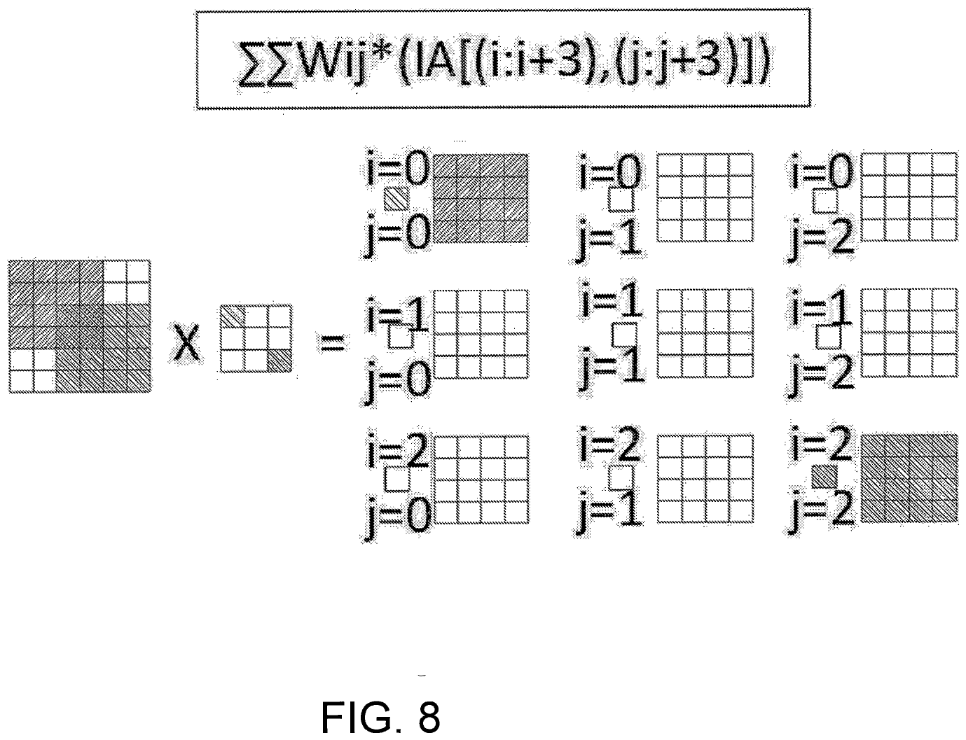

Let the four multiplier units included in one multiplier group MAC4 be MACn (MAC0, MAC1, MAC2, MAC3). For a wave tensor with 16 destinations, each multiplier unit MACn can process 4, so set a multiplier unit MACn including 4 target registers OAmn, n and m are a natural number from 0 to 3, that is, each of the multiplier groups is provided with a 4 row 4 column target register Array, as shown in FIG. 8, m and n respectively represent the rows and columns of each target register in the display;

The weight data and its position index (i, j) in the kernel are received by a multiplier group MAC4, which also receives the input activation data placed in a 6×6 feature map array with them. a position index (s, t) in the array, the i and j respectively representing a row and column of the 3×3 kernel array, the s and t respectively representing a row and column of the 6×6 feature map array, i, j being 0 to a natural number in 2; s, t is a natural number from 0 to 5;

For each weighted array element W(i,j), all input activation data whose position satisfies the condition 0<=(si) <=3 and 0<=(tj) <=3, and the W(i,j)) are sent together to the MAC (tj), they are multiplied, and the result is processed by the destination register (sj) (the destination register of the m=sj line), which is cumulative, maximum or minimum according to user requirements, tj, The calculation result obtained by sj is a natural number from 0 to 3, sj represents the row coordinate of the target register obtained by subtracting j from j, or m value; tj represents the coordinate of the column of the target register obtained by subtracting j from j, or MACn the value of n.

In MAC4, for each W, all matching IAs will be found according to the algorithm in FIG. 8, and will be sent to the MAC containing the W for processing. After processing all the Ws in the kernel, the result either remains in the register to get more input channels, or switches to the export register for export.

For those with a basic knowledge of artificial intelligence, the W and IA matching algorithms of the 3×3 core disclosed according to the present embodiment are easily extended to other kernel sizes. The basic principles, main features, and advantages of the present invention are shown and described above. It should be understood by those skilled in the art that the present invention is not limited by the foregoing embodiments, and that the present invention is only described in the foregoing description and the description of the present invention, without departing from the spirit and scope of the invention. The scope of the invention is defined by the appended claims, the description and the equivalents thereof.

Apparently, the aforementioned embodiments are merely examples illustrated for clearly describing the present application, rather than limiting the implementation ways thereof. For a person skilled in the art, various changes and modifications in other different forms may be made on the basis of the aforementioned description. It is unnecessary and impossible to exhaustively list all the implementation ways herein. However, any obvious changes or modifications derived from the aforementioned description are intended to be embraced within the protection scope of the present application.

The example embodiments may also provide at least one technical solution to a technical challenge. The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Although process steps, method steps, algorithms, or the like, may be described in a sequential order, such processes, methods and algorithms may be conFIG.d to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

In various embodiments, a hardware module may be implemented mechanically or electronically. For example, a hardware module may comprise dedicated circuitry or logic that is permanently conFIG.d (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily conFIG.d by software to perform certain operations. It will be appreciated that the decision to implement a hardware module mechanically, in dedicated and permanently conFIG.d circuitry, or in temporarily conFIG.d circuitry (e.g., conFIG.d by software) may be driven by cost and time considerations.

The various operations of example methods described herein may be performed, at least partially, by one or more processors that are temporarily conFIG.d (e.g., by software) or permanently conFIG.d to perform the relevant operations. Whether temporarily or permanently conFIG.d, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

While the disclosure has been described in terms of exemplary embodiments, those skilled in the art will recognize that the disclosure can be practiced with modifications that fall within the spirit and scope of the appended claims. These examples given above are merely illustrative and are not meant to be an exhaustive list of all possible designs, embodiments, applications, or modification of the disclosure.

In summary, the integrated circuit with a plurality of transistors, each of which may have a gate dielectric with properties independent of the gate dielectric for adjacent transistors provides for the ability to fabricate more complex circuits on a semiconductor substrate. The methods of fabricating such an integrated circuit structures further enhance the flexibility of integrated circuit design. Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. A core computing unit processor for an artificial intelligence device, comprising a plurality of neurons, wherein the neurons are composed of a plurality of multiplier groups, the multiplier group comprising a plurality of multipliers An adder unit having an operation function of accumulating, maximizing, and minima, wherein the number of multiplier groups in each neuron is the same, and the number of multiplier units in each multiplier group is the same, one nerve The multiplier group in the element shares the same input activation data, and the multiplier group in one neuron processes different kernel weight data, but the multiplier group in the same order in different neurons processes the same kernel weight data, each There is no data conversion between the multiplier groups.

2. The core computing unit processor for the artificial intelligence device according to claim 1, comprising four neurons, said neurons being composed of eight multiplier groups, said multiply adding The set includes four multiplier units.

3. The core computing unit processor for the artificial intelligence device according to claim 1, wherein the input end of the multiplier unit is connected to a weight register and an input activation register, respectively. a multiplier MAC, a plurality of target registers and a plurality of export registers are provided in the unit; the target register is connected to the multiplier MAC for storing the calculation result of the weight and the input activation data; the export register and the target The registers are connected and correspond one-to-one with the target registers for the derivation of the result.

4. The core computing unit processor for the artificial intelligence device according to claim 3, wherein the multiplier unit is provided with four export registers and four target registers.

5. The core computing unit processor for the artificial intelligence device according to claim 3, wherein said processor comprises a buffer L1 for storing input dispatched by an external module. The data and weight data are activated, and the input activation register and weight register call data from the buffer L1.

6. The core computing unit processor for the artificial intelligence device according to claim 5, wherein said external module is a wave tensor dispatcher.

7. An artificial intelligence device core computing unit acceleration processing method comprising the steps of:
The data processed by the multiplier unit includes non-zero weight data and its position index in the kernel, non-zero input activation data and its position index in the feature map, and different kernel weight data are respectively mapped to one Different sets of multipliers in the neuron and broadcast to the corresponding multiplier group in other neurons; the multiplier group processing in one neuron shares the same input activation data, with the same feature dimension, but from The input activation data of the different input channels are accumulated in the same multiplier group, which is the position of the input activation data on the feature map.

8. The artificial intelligence device core computing unit acceleration processing method according to claim 7, wherein in the multiplier unit, the result of multiplying the weight data by the input activation data is accumulated or performed with the previous result. Compare to get the maximum or minimum result and store it in the destination register.

9. The artificial intelligence device core computing unit acceleration processing method according to claim 7, wherein the processor is provided with four neurons, and the neurons are composed of eight multiplier groups MAC4, The MAC4 includes four multiplier units, the multiplier unit is provided with a multiplier MAC, four target registers and four derivation registers, and the target register and the export register are in one-to-one correspondence, and the input end of the multiplier MAC is The weight register and the input activation register are respectively connected; the target register is connected to the output end of the multiplier MAC for storing the calculation result of the weight and the input activation data; the export register is connected with the target register, and is used for deriving the calculation result.

10. The artificial intelligence device core computing unit acceleration processing method according to claim 8, wherein the weighting data of the 3×3 kernel and the input activation data matching algorithm comprise: configuring a multiplier group MAC4 include 4 identical multiplier units MACn. For a wave tensor with 16 destinations, each multiplier unit MACn can process 4 of them, so a multiplier The unit MACn includes four target registers OAmn, n and m are a natural number from 0 to 3, that is, each of the multiplier groups is provided with a target register array of 4 rows and 4 columns, and m and n respectively represent each target. The rows and columns of registers in the display;
The weight data and its position index (i, j) in the kernel are received by a multiplier group MAC4, which also receives the input activation data placed in a 6×6 feature map array with them. a position index (s, t) in the array, the i and j respectively representing a row and column of the 3×3 kernel array, the s and t respectively representing a row and column of the 6×6 feature map array, i, j being 0 to a natural number in 2; s, t is a natural number from 0 to 5;
For each weighted array element W(i,j), all input activation data whose position satisfies the condition 0<=(si) <=3 and 0<=(tj) <=3, and the W(i,j)) are sent together to MAC(tj), they are multiplied, and the result is processed by the target register (sj). This processing is cumulative, maximum or minimum according to user requirements, and tj and sj are a natural number from 0 to 3. Sj represents the row coordinate of the target register, tj represents the column coordinate of the target register, or the n value of MACn.
